(19) United States
(12) Patent Application Publication
(10) Pub. No.: US 2026/0109360 A1
(43) Pub. Date: Apr. 23, 2026

(54) ONBOARD BACKUP CONTROL DEVICE

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); Toyota Jidosha Kabushiki Kaisha, Toyota-shi, Aichi (JP)

(72) Inventors: Takeshi HASEGAWA, Yokkaichi-shi, Mie (JP); Kazuki MASUDA, Yokkaichi-shi, Mie (JP); Yuki SANO, Osaka-shi, Osaka (JP); Yukiyoshi UENO, Toyota-Shi, Aichi (JP); Ryosuke TAKAHASHI, Toyota-shi, Aichi (JP); Tatsunori MORI, Toyota-shi, Aichi (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP); Toyota Jidosha Kabushiki Kaisha, Toyota-shi, Aichi (JP)

(21) Appl. No.: 18/996,382

(22) PCT Filed: Jul. 28, 2022
(86) PCT No.: PCT/JP2022/029128

§ 371 Date: Dec. 19, 2025

(51) Int. Cl. B60W 50/02; H02J 1/08; H02J 7/34

(52) U.S. Cl. CPC B60W 50/0225; H02J 1/086; H02J 7/345

(57) ABSTRACT

An onboard backup control device performs a backup operation of supplying power to a load based on power from a first power storage and a second power storage at least in a predetermined state where supply of power from a power source unit to the load is interrupted or reduced. The onboard backup control device includes a supply circuit that supplies power from the first power storage and the second power storage to the load, and a first controller and a second controller that control an operation of supplying power from the first power storage to the load and an operation of supplying power from the second power storage to the load in the supply circuit.

### CROSS-REFERENCE TO RELATED APPLICATIONS

This application is the U.S. national stage of PCT/JP2022/029128 filed on Jul. 28, 2022, the contents of which is incorporated herein.

### TECHNICAL FIELD

The present disclosure relates to an onboard backup control device.

### BACKGROUND

JP 2009-296808 A discloses a power storage device configured to supply power from a power storage to a load when a voltage of a main power source drops. A control circuit of this power storage device charges the power storage by controlling a charging circuit when the main power source is normal. When the voltage of the main power source drops (e.g., when the engine is started after the end of idling stop), this control circuit turns on a switch disposed between the power storage and the load to supply power to the load. JP 2009-296808 A describes that this power storage device can be used also as a power source backup system when the main power source is abnormal.

The power storage device of JP 2009-296808 A is configured such that power is supplied for a load that is a backup target from one power storage. However, with such a configuration, there is only one power source for the load at the time of backup, limiting power supply methods.

An object of the present disclosure is to be able to use, at the time of backup operation, both of an operation of supplying power from a first power storage and an operation of supplying power from a second power storage for a common load.

### SUMMARY

An onboard backup control device according to one aspect of the present disclosure is an onboard backup control device configured to be used in an onboard power supply system including a power source unit and a power storage, and to perform a backup operation of supplying power to a load based on power from the power storage in a predetermined state where supply of power from the power source unit to the load is interrupted or reduced, in which the power storage includes a first power storage and a second power storage, the load includes a predetermined common load, and the onboard backup control device includes a supply circuit that supplies power from the first power storage and the second power storage to the common load, and a controller that controls an operation of supplying power from the first power storage to the common load and an operation of supplying power from the second power storage to the common load in the supply circuit.

### Advantageous Effects

The technology according to the present disclosure can use, at the time of the backup operation, both of the operation of supplying power from the first power storage and the operation of supplying power from the second power storage for the common load.

### BRIEF DESCRIPTION OF DRAWINGS

FIG. 1 is a block diagram schematically illustrating an onboard power supply system including an onboard backup control device of a first embodiment.

FIG. 2 is a flowchart showing a flow of control performed by the onboard backup control device of the first embodiment.

FIG. 3 is a block diagram schematically illustrating an onboard power supply system including an onboard backup control device of a second embodiment.

FIG. 4 is a block diagram schematically illustrating an onboard power supply system including an onboard backup control device of a third embodiment.

### DETAILED DESCRIPTION OF PREFERRED EMBODIMENTS

Hereinafter, embodiments of the present disclosure will be listed and exemplified. Note that the first through the fifth aspects exemplified below may be combined in any manner within a range not contradictory.

In a first aspect, an onboard backup control device configured to be used in an onboard power supply system including a power source unit and a power storage, and to perform a backup operation of supplying power to a load based on power from the power storage in a predetermined state where supply of power from the power source unit to the load is interrupted or reduced, in which the power storage includes a first power storage and a second power storage, the load includes a predetermined common load, and the onboard backup control device includes a supply circuit that supplies power from the first power storage and the second power storage to the common load, and a controller that controls an operation of supplying power from the first power storage to the common load and an operation of supplying power from the second power storage to the common load in the supply circuit.

The onboard backup control device of the first aspect described above can perform the backup operation using the power storage in a predetermined state where the supply of power from the power source unit is interrupted or reduced. This backup control device can supply power from the first power storage and the second power storage for a predetermined common load. Therefore, the backup control device can use, at the time of the backup operation, both of the operation of supplying power from the first power storage and the operation of supplying power from the second power storage for the common load.

In a second aspect, the onboard backup control device according to the first aspect has the following features. The onboard backup control device further includes the first power storage and the second power storage.

By including the first power storage and the second power storage, the onboard backup control device of the second aspect described above can complete the backup operation within the device.

In a third aspect, the onboard backup control device according to the first or the second aspect has the following features. The supply circuit includes a first supply circuit and a second supply circuit. The first supply circuit outputs power based on the first power storage toward the second supply circuit. The second supply circuit switches between a state of supplying, to the common load, power based on an input from the first supply circuit, and a state of supplying, to the common load, power based on the second power storage.

The onboard backup control device of the third aspect described above can switch between a state of supplying power from the first power storage and a state of supplying power from the second power storage, and can select the supply source of power from the first power storage or the second power storage. In addition, the second supply circuit has a function of supplying power from the second power storage and a function of switching between a state of supplying power from the first power storage and a state of supplying power from the second power storage, for the common load. Therefore, the configuration of the onboard backup control device can be simplified as compared with the case of separately providing a configuration having a function of switching between a state of supplying power from the first power storage and a state of supplying power from the second power storage.

In a fourth aspect, the onboard backup control device according to the third aspect has the following features. The supply circuit includes a first supply circuit and a second supply circuit. The second supply circuit outputs power based on the second power storage toward the first supply circuit. The first supply circuit switches between a state of supplying, to the common load, power based on an input from the second supply circuit, and a state of supplying, to the common load, power based on the first power storage.

In the onboard backup control device of the fourth aspect described above, the first supply circuit also can be provided with a function of switching between a state of supplying power from the first power storage and a state of supplying power from the second power storage.

In a fifth aspect, the onboard backup control device according to the first or the second aspect has the following features. The supply circuit includes a first supply circuit, a second supply circuit, and a switching unit. The first supply circuit outputs power based on the first power storage. The second supply circuit outputs power based on the second power storage. The switching unit switches between a state of supplying, to the common load, power based on an output from the first supply circuit, and a state of supplying, to the common load, power based on an output from the second supply circuit.

The onboard backup control device of the fifth aspect described above can switch between a state of supplying power from the first power storage and a state of supplying power from the second power storage, and can select the supply source of power from the first power storage or the second power storage. In addition, since the switching unit is provided separately from the first supply circuit and the second supply circuit, it is possible to simplify the configurations of the first supply circuit and the second supply circuit.

### First Embodiment

### Configuration of Onboard Power Supply System

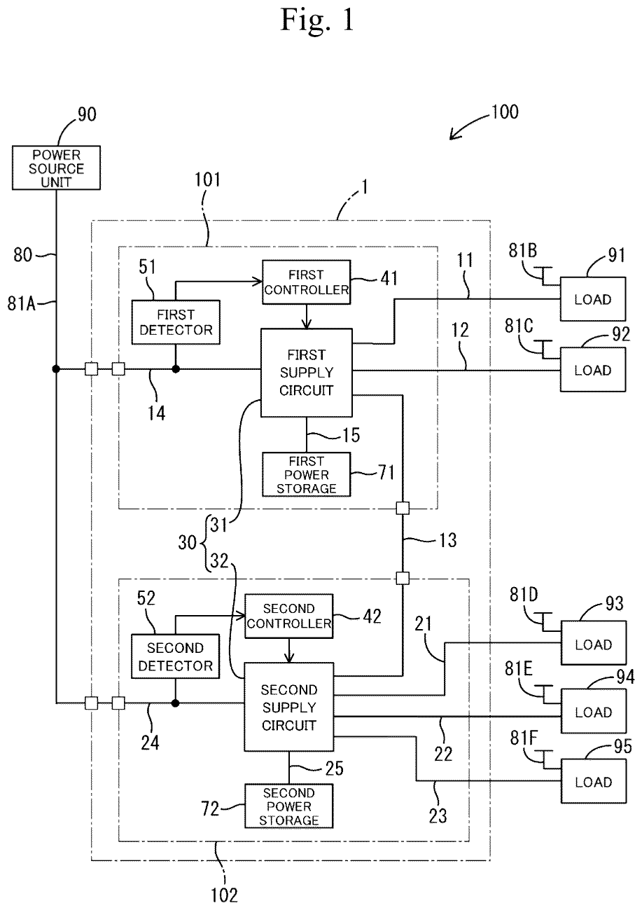

An onboard power supply system 100 illustrated in FIG. 1 includes a power source unit 90, loads 91, 92, 93, 94, and 95, and an onboard backup control device 1. The onboard backup control device 1 is also referred to as a backup control device 1.

The power source unit 90 functions as a main power source that continuously supplies power once a vehicle mounted with the onboard power supply system 100 is started. The power source unit 90 is a DC power source which generates a DC voltage. The power source unit 90 is implemented as a battery such as a lead battery, for example. A high-potential side terminal of the power source unit 90 is electrically connected to a power path 80, and a low-potential side terminal of the power source unit 90 is electrically connected to the ground. The power source unit 90 applies a predetermined voltage to the power path 80. In the description herein, the voltage is a voltage with the ground as a reference, unless otherwise specified.

The power source unit 90 is electrically connected to the loads 91, 92, 93, 94, and 95 via the power path 80. The power from the power source unit 90 is supplied to the loads 91, 92, 93, 94, and 95 via the power path 80. In the example illustrated in FIG. 1, the power path 80 includes a power path 81A, which is a conduction path directly connected to the power source unit 90, a power path 81B connected to the load 91, a power path 81C, which is a conduction path connected to the load 92, a power path 81D, which is a conduction path connected to the load 93, a power path 81E, which is a conduction path connected to the load 94, and a power path 81F, which is a conduction path connected to the load 95. The power paths 81A, 81B, 81C, 81D, 81E, and 81F are electrically connected to one another. In a state where the power is supplied from the power source unit 90 to the loads 91, 92, 93, 94, and 95, the power paths 81A, 81B, 81C, 81D, 81E, and 81F are at the same potential. The power path 80 is provided with a relay, a fuse, and the like, not illustrated, and these elements have a function of cutting off the conduction of the power path 80.

The loads 91, 92, 93, 94, and 95 are onboard electrical devices to be installed on the vehicle. The loads 91, 92, 93, 94, and 95 are loads for which power supply is desired in an abnormal state (failure state) where power supply from the power source unit 90 stops. The loads 91, 92, 93, 94, and 95 may be actuators such as motors, for example. Alternatively, they may be ECUs or actuators in an electric parking brake system, ECUs or actuators in a shift-by-wire control system, or the like. Alternatively, they may be onboard electric devices other than those mentioned above.

The load 93 corresponds to an example of the “predetermined common load” of the present disclosure. To the load 93, it is possible to supply power from a first power storage 71 via a first supply circuit 31 described later and to supply power from a second power storage 72 via a second supply circuit 32 described later.

The backup control device 1 includes a supply circuit 30, a first controller 41, a second controller 42, a first detector 51, a second detector 52, the first power storage 71, and the second power storage 72. The supply circuit 30 includes the first supply circuit 31 and the second supply circuit 32. The first controller 41 and the second controller 42 correspond to an example of the “controller” of the present disclosure. The first power storage 71 and the second power storage 72 correspond to an example of the “power storage” of the present disclosure. The backup control device 1 is a device capable of performing a backup operation of supplying power to the loads 91, 92, 93, 94, and 95 based on the power of the first power storage 71 and the second power storage 72 in a predetermined state (abnormal state) where the power supply from the power source unit 90 to the loads 91, 92, 93, 94, and 95 is interrupted or reduced.

The backup control device 1 includes a first power storage unit 101 and a second power storage unit 102. The first power storage unit 101 includes the first power storage 71, the first controller 41 described later, the first supply circuit 31, and the first detector 51. The second power storage unit 102 includes the second power storage 72, the second controller 42 described later, the second supply circuit 32, and the second detector 52.

The first power storage 71 and the second power storage 72 function as auxiliary power supplies. The first power storage 71 and the second power storage 72 are DC power supplies which output DC voltages, and are, for example, electric double layer capacitors. The first power storage 71 is electrically connected to a first supply circuit 31 described later via a conduction path 15, and is charged and discharged via the first supply circuit 31. The charge voltage (output voltage) of the first power storage 71 is a voltage applied to the conduction path 15. A high-potential side terminal of the first power storage 71 is electrically connected to the conduction path 15 and is at the same potential as the conduction path 15. A low-potential side terminal of the first power storage 71 is electrically connected to the ground and is at the same potential as the ground.

The second power storage 72 is electrically connected to the second supply circuit 32 described later via a conduction path 25, and is charged and discharged via the second supply circuit 32. The charge voltage (output voltage) of the second power storage 72 is a voltage applied to the conduction path 25. A high-potential side terminal of the second power storage 72 is electrically connected to the conduction path 25 and is at the same potential as the conduction path 25. A low-potential side terminal of the second power storage 72 is electrically connected to the ground and is at the same potential as the ground.

In the backup control device 1, in a stop state where a start switch of the vehicle mounted with the onboard power supply system 100 is in an off state, the charge voltages (output voltages) of the first power storage 71 and the second power storage 72 are kept equal to or lower than a standby voltage. Then, in response to the start switch of the vehicle being switched to an on state, the backup control device 1 performs charging so as to make the charge voltages of the first power storage 71 and the second power storage 72 equal to or larger than a target voltage which is larger than the standby voltage. While the start switch of the vehicle is in the on state, the charge voltages of the first power storage 71 and the second power storage 72 are maintained at the target voltage unless any failure state occurs. When the start switch of the vehicle is switched from the on state to the off state, the backup control device 1 discharges the first power storage 71 and the second power storage 72 until the charge voltages of the first power storage 71 and the second power storage 72 become equal to or lower than the standby voltage.

The first supply circuit 31 functions so as to supply power from the first power storage 71 to the loads 91 and 92 and the second supply circuit 32. The second supply circuit 32 functions so as to supply power to the loads 94 and 95.

The first supply circuit 31 outputs power based on the first power storage 71 toward the second supply circuit 32. The first supply circuit 31 operates based on control of the first controller 41 described later. The first supply circuit 31 is disposed between a conduction path 14 and conduction paths 11, 12, and 13. The first supply circuit 31 includes a voltage conversion circuit such as a DCDC converter, for example. The voltage conversion circuit performs a charging operation and a discharging operation for the first power storage 71. As the charging operation, the voltage conversion circuit performs a voltage conversion operation of stepping up or stepping down the voltage applied to the conduction path 14, and applying the resultant voltage to the conduction path 15. As the discharging operation, the voltage conversion circuit performs a voltage conversion operation of stepping up or stepping down the voltage applied to the conduction path 15, and applying the resultant voltage to the conduction path 11 and the like.

The second supply circuit 32 switches between a state of supplying, to the load 93, power based on an input from the first supply circuit 31, and a state of supplying, to the load 93, power based on the second power storage 72. The second supply circuit 32 operates based on control of the second controller 42 described later. The second supply circuit 32 is disposed between a conduction path 24 and conduction paths 21, 22, and 23. The second supply circuit 32 includes a voltage conversion circuit such as a DCDC converter, for example. The voltage conversion circuit performs a charging operation and a discharging operation for the second power storage 72. As the charging operation, the voltage conversion circuit performs a voltage conversion operation of stepping up or stepping down the voltage applied to the conduction path 24, and applying the resultant voltage to the conduction path 25. In a case of supplying power based on the second power storage 72 to the load 93, the voltage conversion circuit performs, as the discharging operation, a voltage conversion operation of stepping up or stepping down the voltage applied to the conduction path 25, and applying the resultant voltage to the conduction path 21 and the like.

The first controller 41 controls an operation of supplying power from the first power storage 71 to the load 91, the load 92, and the second supply circuit 32. The first controller 41 is an information processing device including functions such as an information processing function, an arithmetic function, and a control function. The first controller 41 is configured mainly as a microcomputer, for example, and includes components such as an arithmetic device e.g., a central processing unit (CPU), a memory e.g., a read only memory (ROM) or a random-access memory (RAM), and an A/D converter. The first controller 41 has a function of controlling the first supply circuit 31.

The second controller 42 controls an operation of supplying power from the second power storage 72 to the loads 93, 94, and 95. The second controller 42 is an information processing device including functions such as an information processing function, an arithmetic function, and a control function. The second controller 42 is configured mainly as a microcomputer, for example, and includes components such as an arithmetic device e.g., a central processing unit (CPU), a memory e.g., a read only memory (ROM) or a random access memory (RAM), and an A/D converter. The second controller 42 has a function of controlling the second supply circuit 32.

The first detector 51 is configured as a voltage detection circuit, for example. The first detector 51 detects the voltage of the conduction path 14. The conduction path 14 is a conduction path electrically connected to the power path 80 and having the same potential as the power path 80. Therefore, the first detector 51 can detect the voltage of the power path 80.

The conduction path 11 is a conduction path between the first supply circuit 31 and the load 91. The conduction path 12 is a conduction path between the first supply circuit 31 and the load 92. The conduction path 13 is a conduction path between the first supply circuit 31 and the second supply circuit 32.

The second detector 52 is configured as a voltage detection circuit, for example. The second detector 52 detects the voltage of the conduction path 24. The conduction path 24 is a conduction path electrically connected to the power path 80 and having the same potential as the power path 80. Therefore, the second detector 52 can detect the voltage of the power path 80.

The conduction path 21 is a conduction path between the second supply circuit 32 and the load 93. The conduction path 22 is a conduction path between the second supply circuit 32 and the load 94. The conduction path 23 is a conduction path between the second supply circuit 32 and the load 95.

### Operation of Backup Control Device

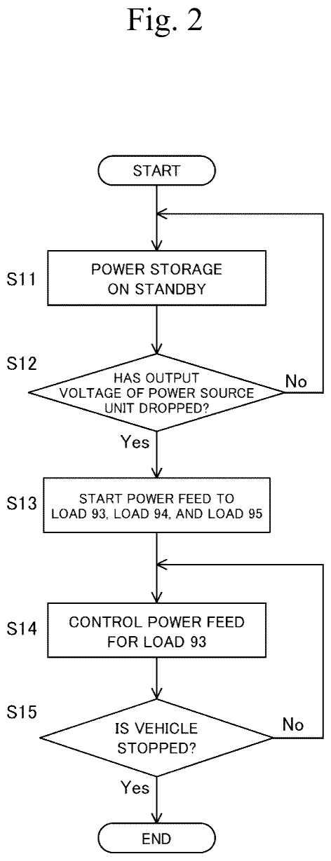

FIG. 2 shows an example of backup control performed by the backup control device 1 (specifically, the first controller 41 and the second controller 42). The first controller 41 and the second controller 42 start the backup control of FIG. 2 when a predetermined start condition is satisfied. The condition for starting the backup control of FIG. 2 may be, for example, that the start switch of the vehicle mounted with the onboard power supply system 100 is switched from the off state to the on state, or may be another condition. In representative example described below, when the start switch of the vehicle is switched from the off state to the on state, a start signal indicating that the start switch has been switched to the on state is given from an external device (e.g., an external electronic controller (ECU) ) to the first controller 41 and the second controller 42. When receiving such a start signal, the first controller 41 and the second controller 42 start the backup control of FIG. 2.

When the backup control of FIG. 2 is started, the first controller 41 and the second controller 42 perform charging in step S11 so as to make the charge voltages of the first power storage 71 and the second power storage 72 equal to or larger than the target voltage which is larger than the standby voltage. The first controller 41 and the second controller 42 maintain the charge voltages of the first power storage 71 and the second power storage 72 at the target voltage.

In step S12, the first controller 41 and the second controller 42 determine whether the output voltage of the power source unit 90 (main power source) has dropped (whether it is in a predetermined low state) or not. The first controller 41 determines whether the voltage of the conduction path 14 is less than a threshold (whether it is in a predetermined low state) or not based on the voltage detected by the first detector 51, for example. This threshold is a value significantly smaller than the output voltage applied to the power path 80 when the power source unit 90 is normal, and is a value larger than 0. Alternatively, the second controller 42 may determine whether the voltage of the conduction path 24 is less than a threshold (whether it is in a predetermined low state) or not based on the voltage detected by the second detector 52. When it is determined in step 12 that the voltage of the conduction path 14 is less than the threshold (Yes in step S12), the first controller 41 advances the processing to step S13. In the present representative example, a case where the voltage of the conduction path 14 is less than a threshold, that is, a case where the voltage of the power path 80 is less than a threshold, corresponds to an example of the “predetermined state” of the present disclosure. When it is determined in step 12 that the voltage of the conduction path 14 is equal to or larger than the threshold (No in step S12), the first controller 41 performs the processing of step S11 again.

For example, in an abnormal state where a ground fault, a disconnection, or the like occurs in the power path 80, and power supply from the power source unit 90 to the conduction paths 14 and 24 and power supply to the power paths 81B, 81C, 81D, 81E, and 81F are lost, the voltages of the conduction paths 14 and 24 become about 0 V. In such a case, in the backup control device 1, the first controller 41 and the second controller 42 perform the backup operation of supplying power to the plurality of loads 91, 92, 93, 94, and 95 based on the power from the first power storage 71 and the second power storage 72. The second controller 42 performs the processing in and after step S13 for the loads 93, 94, and 95. Hereinafter, description regarding the backup operation by the first controller 41 for the loads 91 and 92 will be omitted, and an example in which power is supplied by the second controller 42 to the loads 93, 94, and 95 will be described.

When it is determined in step S12 that the voltage of the conduction path 14 is less than the threshold (Yes in step S12), the second controller 42 starts power feed to the loads 93, 94, and 95 in step S13. The second controller 42 causes the second supply circuit 32 to perform an operation of supplying power to the conduction paths 21, 22, and 23.

In subsequent step S14, the second controller 42 performs power feed control for the load 93. The second controller 42 causes the second supply circuit 32 to switch between a state of supplying, to the load 93, power based on an input from the first supply circuit 31, and a state of supplying, to the load 93, power based on the second power storage 72. In a case of supplying, to the load 93, power based on an input from the first supply circuit 31, the second controller 42 causes the second supply circuit 32 to operate such that a voltage (voltage of a magnitude V1) applied to the conduction path 13 is applied to the conduction path 21. The voltage V1 is a voltage resulting from stepping up or stepping down the output voltage from the first power storage 71 by the voltage conversion circuit of the first supply circuit 31. In the case of supplying, to the load 93, power based on the second power storage 72, the second controller 42 causes the second supply circuit 32 to operate such that a voltage (voltage of a magnitude V2) based on the output voltage of the second power storage 72 is applied to the conduction path 21. The voltage V2 is a voltage resulting from stepping up or stepping down the output voltage from the second power storage 72 by the voltage conversion circuit of the second supply circuit 32. The voltage V1 and the voltage V2 may have the same magnitude (slightly different values).

In subsequent step S15, the first controller 41 and the second controller 42 determine whether or not the vehicle mounted with the onboard power supply system 100 is in a stop state. The first controller 41 and the second controller 42 determine whether or not the start switch of the vehicle mounted with the onboard power supply system 100 has been switched from the on state to the off state. For example, when the start switch of the vehicle is switched from the on state to the off state, a start signal indicating that the start switch has been switched to the off state is given from an external device (e.g., an external electronic controller (ECU)) to the first controller 41 and the second controller 42. When receiving such a start signal, the first controller 41 and the second controller 42 determine that the vehicle is in a stop state. When it is determined in step S15 that the vehicle is not in the stop state (is in an activation state) (No in step S15), the first controller 41 and the second controller 42 perform the processing of step S14 again. When it is determined in step S15 that the vehicle is in the stop state (Yes in step S15), the first controller 41 and the second controller 42 end the backup control of FIG. 2.

The following description is related to an example of effects of the present configuration.

The backup control device 1 can perform the backup operation using the first power storage 71 and the second power storage 72 in a predetermined state where the supply of power from the power source unit 90 is interrupted or reduced. This backup control device 1 can supply power from the first power storage 71 and the second power storage 72 for the load 93. Therefore, the backup control device 1 can use, at the time of the backup operation, both of the operation of supplying power from the first power storage 71 and the operation of supplying power from the second power storage 72 for the load 93.

The backup control device 1 further includes the first power storage 71 and the second power storage 72. Therefore, by including the first power storage 71 and the second power storage 72, the backup control device 1 can complete the backup operation within the device.

Furthermore, the backup control device 1 can switch between a state of supplying power from the first power storage 71 and a state of supplying power from the second power storage 72, and can select the supply source of power from the first power storage 71 or the second power storage 72. In addition, the second supply circuit 32 has a function of supplying power from the second power storage 72 and a function of switching between a state of supplying power from the first power storage 71 and a state of supplying power from the second power storage 72, for the load 93. Therefore, the configuration of the backup control device 1 can be simplified as compared with the case of separately providing a configuration having a function of switching between a state of supplying power from the first power storage 71 and a state of supplying power from the second power storage 72.

### Second Embodiment

An onboard power supply system 200 of the second embodiment includes a switching unit 33, is different from that of the first embodiment in that power to be supplied to the load 93 is switched by the switching unit 33, but the other configurations are the same. The same components as those of the first embodiment are denoted by the same reference signs, and detailed description thereof will be omitted.

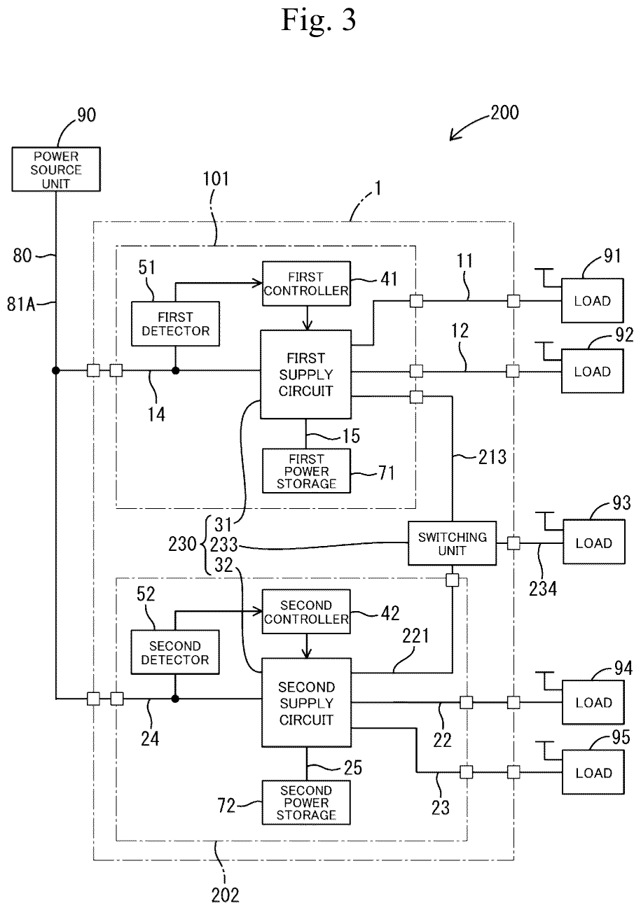

As illustrated in FIG. 3, the onboard power supply system 200 includes the onboard backup control device 1 (also referred to as the backup control device 1). A supply circuit 230 of the backup control device 1 includes a first supply circuit 31, a second supply circuit 32, and a switching unit 233. The first supply circuit 31 functions so as to supply power to the switching unit 233. The first supply circuit 31 outputs power based on the first power storage 71 toward the switching unit 233 via a conduction path 213. The conduction path 213 is a conduction path between the first supply circuit 31 and the switching unit 233.

The second supply circuit 32 functions so as to supply power to the switching unit 233. The second supply circuit 32 outputs power based on the second power storage 72 toward the switching unit 233 via a conduction path 221. The conduction path 221 is a conduction path between the second supply circuit 32 and the switching unit 233. A conduction path 234 is a conduction path between the switching unit 233 and the load 93.

The switching unit 233 switches between a state of supplying, to the load 93, power based on an output from the first supply circuit 31, and a state of supplying, to the load 93, power based on an output from the second supply circuit 32. The switching unit 233 includes, for example, a switch. The switching unit 233 operates under control of the first controller 41 and the second controller 42, for example.

### Operation of Backup Control Device

The backup control performed by the backup control device 1 (specifically, the first controller 41 and the second controller 42) of the second embodiment is different from that of the first embodiment only in step S14.

In step S14, the first controller 41 and the second controller 42 perform power feed control for the load 93. The first controller 41 and the second controller 42 cause the switching unit 233 to switch between a state of supplying, to the load 93, power based on an input from the first supply circuit 31, and a state of supplying, to the load 93, power based on the second power storage 72. In a case of supplying, to the load 93, power based on an input from the first supply circuit 31, the switching unit 233 operates such that a voltage (voltage of a magnitude V 21) applied to the conduction path 213 is applied to the conduction path 234. The voltage V21 is a voltage resulting from stepping up or stepping down the output voltage from the first power storage 71 by the voltage conversion circuit of the first supply circuit 31. In a case of supplying power based on the second power storage 72 to the load 93, the first controller 41 and the second controller 42 operates such that a voltage (voltage of magnitude V 22) based on the output voltage of the second power storage 72 is applied to the conduction path 234. The voltage V22 is a voltage resulting from stepping up or stepping down the output voltage from the second power storage 72 by the voltage conversion circuit of the second supply circuit 32. The voltage V21 and the voltage V22 may have the same magnitude (slightly different values).

The following description is related to an example of effects of the present configuration.

In the backup control device 1, the supply circuit 230 includes the first supply circuit 31, the second supply circuit 32, and the switching unit 233. The switching unit 233 switches between a state of supplying, to the load 93, power based on an output from the first supply circuit 31, and a state of supplying, to the load 93, power based on an output from the second supply circuit 32. Therefore, the backup control device 1 can switch between a state of supplying power from the first power storage 71 and a state of supplying power from the second power storage 72, and can select the supply source of power from the first power storage 71 or the second power storage 72. In addition, since the switching unit 233 is provided separately from the first supply circuit 31 and the second supply circuit 32, it is possible to simplify the configurations of the first supply circuit 31 and the second supply circuit 32.

### Third Embodiment

An onboard power supply system 300 of the third embodiment is different from that of the first embodiment in that the first power storage unit 101 has a function of switching the power source for the load 93, but the other configurations are the same. The same components as those of the first embodiment are denoted by the same reference signs, and detailed description thereof will be omitted.

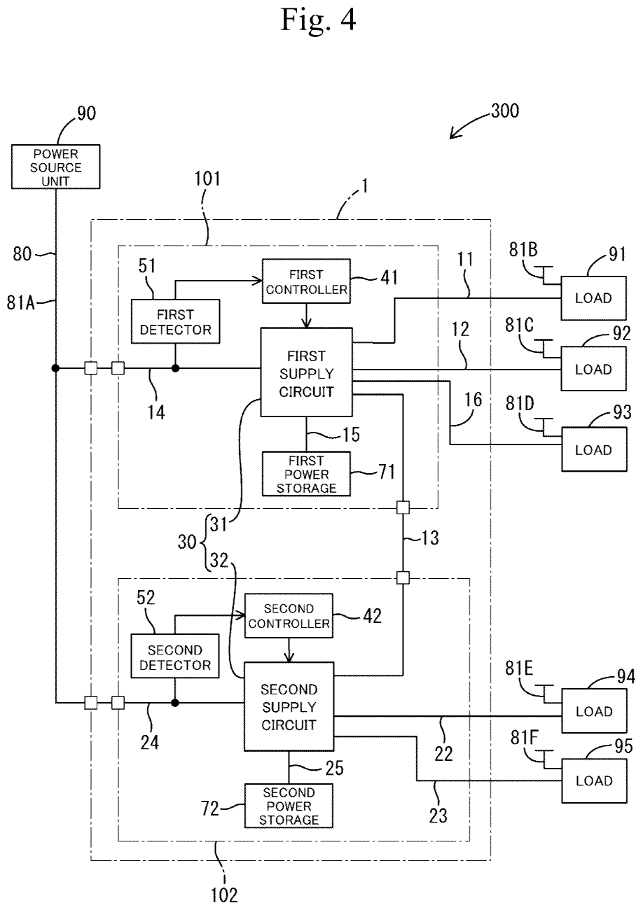

As illustrated in FIG. 4, the onboard power supply system 300 includes a conduction path 16. The conduction path 16 is a conduction path between the first supply circuit 31 and the load 93. The first supply circuit 31 switches between a state of supplying, to load 93, power based on an input from the second supply circuit 32, and a state of supplying, to load 93, power based on the first power storage 71.

The backup control by the backup control device 1 of the third embodiment is mainly similar to that of the first embodiment (see FIG. 2), but the control described below is different. In the backup control device 1 of the third embodiment, the first supply circuit 31 has a function of switching the power source (the first power storage 71 and the second power storage 72).

In step S14 (see FIG. 2) of the backup control, the first supply circuit 31 performs switching control of the power source. The first controller 41 causes the first supply circuit 31 to switch between a state of supplying, to load 93, power based on an input from the second supply circuit 32 and a state of supplying, to load 93, power based on the first power storage 71. In a case of supplying, to the load 93, power based on an input from the second supply circuit 32, the first controller 41 causes the first supply circuit 31 to operate such that a voltage (voltage of the magnitude V2) applied to the conduction path 13 is applied to the conduction path 16. The voltage V2 is a voltage resulting from stepping up or stepping down the output voltage from the second power storage 72 by the voltage conversion circuit of the second supply circuit 32. In a case of supplying, to the load 93, power based on the first power storage 71, the first controller 41 causes the first supply circuit 31 to operate such that a voltage (voltage of the magnitude V1) based on the output voltage of the first power storage 71 is applied to the conduction path 16. The voltage V1 is a voltage resulting from stepping up or stepping down the output voltage from the first power storage 71 by the voltage conversion circuit of the first supply circuit 31. The voltage V1 and the voltage V2 may have the same magnitude (slightly different values).

In the backup control device 1 of the third embodiment, the first supply circuit 31 can be provided with a function of switching between a state of supplying power from the first power storage 71 and a state of supplying power from the second power storage 72.

### Other Embodiments

The present disclosure is not limited to the embodiments described with reference to the description and drawings above. For example, the features of the embodiments described above or below can be combined in any manner within a range not contradictory. In addition, any of the features of the embodiments described above or below can be omitted unless explicitly described as being essential. Furthermore, the embodiments described above may be modified as follows.

In the backup control of the backup control device 1 in the above embodiments, a state in which the voltage of the conduction path 14 is less than the threshold is used as an example of the predetermined state in step S12; however, the predetermined state may be another state. For example, the predetermined state may be a state in which there is a request for a backup operation from the load (specifically, at least one of the first controller 41 and the second controller 42 has received a signal requesting the backup operation from the load).

In the first to third embodiments, power can be supplied from the power source unit 90 to the loads 91, 92, 93, 94, and 95 via the power paths 81B, 81C, 81D, 81E, and 81F, respectively; however, the power paths 81B, 81C, 81D, 81E, and 81F may not be provided. In this case, power in normal times (when the power source unit 90 is normal) is supplied to the loads 91, 92, 93, 94, and 95 directly by the backup power source (the first power storage 71 and the second power storage 72).

In the second embodiment, the first power storage unit 101 and the second power storage unit can perform power feed by backup operation for the common load (load 93), regardless of the presence or absence of a supply path of power to the common load (load 93). Similarly, in the third embodiment, the first power storage unit 101 and the second power storage unit can perform power feed by backup operation for the common load (load 93) independently, even if there is no input from the other unit.

In the third embodiment, a conduction path connecting the second supply circuit 32 and the load 93 may be provided, and not only the first supply circuit 31 but also the second supply circuit 32 may have a function of switching the power source (the first power storage 71 and the second power storage 72).

In the first embodiment, the start switch of the vehicle has been described. The start switch may be an ignition switch. Alternatively, in an electric vehicle or the like, the start switch may be a power switch for instructing the EV system.

In the first embodiment, the power source unit is a lead battery, but is not limited to a lead battery. The power source unit may be, for example, another type of battery such as a lithium ion battery, or may be a power source such as an alternator or a converter.

In the first embodiment, the power storage is an electric double layer capacitor, but the power storage is not limited to the electric double layer capacitor. The power storage may be another type of power storage such as a lithium ion capacitor or a lithium ion battery.

In the first embodiment, the backup control device performs the backup operation when the power supply from the power source unit is lost; however, the backup control device may be configured to perform the backup operation so as to perform power supply from the power storage in a predetermined state without complete loss of the power supply.

It should be understood that the embodiments disclosed herein are illustrative in all respects and are not restrictive. The scope of the present disclosure is not limited to the embodiments disclosed herein, and is intended to include all modifications within the scope defined by the claims or within the scope equivalent to the claims.

1. An onboard backup control device configured to be used in an onboard power supply system including a power source unit and a power storage, and to perform a backup operation of supplying power to a load based on power from the power storage in a predetermined state where supply of power from the power source unit to the load is interrupted or reduced, wherein
the power storage includes a first power storage and a second power storage,
the load includes a predetermined common load,
the onboard backup control device comprises
a supply circuit that supplies power from the first power storage and the second power storage to the common load, and
a controller that controls an operation of supplying power from the first power storage to the common load and an operation of supplying power from the second power storage to the common load in the supply circuit,
the supply circuit includes a first supply circuit and a second supply circuit,
the first supply circuit outputs power based on the first power storage toward the second supply circuit,
the second supply circuit switches between a state of supplying, to the common load, power based on an input from the first supply circuit, and a state of supplying, to the common load, power based on the second power storage,
the onboard backup control device comprises a first power storage unit and a second power storage unit,
the first power storage unit includes the first supply circuit and a first controller that controls an operation of the first supply circuit,
the second power storage unit includes the second supply circuit and a second controller that controls an operation of the second supply circuit, and
the first supply circuit and the second supply circuit each have a DCDC converter.

2. The onboard backup control device according to claim 1, further comprising the first power storage and the second power storage.

3. (canceled)

4. The onboard backup control device according to claim 1, wherein
the second supply circuit outputs power based on the second power storage toward the first supply circuit, and
the first supply circuit switches between a state of supplying, to the common load, power based on an input from the second supply circuit, and a state of supplying, to the common load, power based on the first power storage.

5. An onboard backup control device configured to be used in an onboard power supply system including a power source unit and a power storage, and to perform a backup operation of supplying power to a load based on power from the power storage in a predetermined state where supply of power from the power source unit to the load is interrupted or reduced, wherein
the power storage includes a first power storage and a second power storage,
the load includes a predetermined common load,
the onboard backup control device includes
a supply circuit that supplies power from the first power storage and the second power storage to the common load, and
a controller that controls an operation of supplying power from the first power storage to the common load and an operation of supplying power from the second power storage to the common load in the supply circuit,
the supply circuit includes a first supply circuit, a second supply circuit, and a switching unit,
the first supply circuit outputs power based on the first power storage,
the second supply circuit outputs power based on the second power storage,
the switching unit switches between a state of supplying, to the common load, power based on an output from the first supply circuit, and a state of supplying, to the common load, power based on an output from the second supply circuit,
the onboard backup control device comprises a first power storage unit and a second power storage unit,
the first power storage unit includes the first supply circuit and a first controller that controls an operation of the first supply circuit,
the second power storage unit includes the second supply circuit and a second controller that controls an operation of the second supply circuit, and
the first supply circuit and the second supply circuit each have a DCDC converter.

6. The onboard backup control device according to claim 5, further comprising the first power storage and the second power storage.

7. The onboard backup control device according to claim 2, wherein
the second supply circuit outputs power based on the second power storage toward the first supply circuit, and
the first supply circuit switches between a state of supplying, to the common load, power based on an input from the second supply circuit, and a state of supplying, to the common load, power based on the first power storage.
